(19) United States
(12) Patent Application Publication
(10) Pub. No.: US 2005/0026033 A1
(43) Pub. Date: Feb. 3, 2005

(54) Hermetically sealed battery

(76) Inventors: Katsuya Kawano, Takasaki-City (JP); Motoo Tadokoro, Itano-Gun (JP); Takamasa Obara, Takasaki-City (JP); Fumiyoshi Yoshinari, Tokushima-City (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 10/901,450

(22) Filed: Jul. 29, 2004

(30) Foreign Application Priority Data
Jul. 31, 2003 (JP) 2003-204526

(51) Int. Cl. H01M 2/12; H01M 10/34; H01M 10/50; H01M 10/52; H01M 2/08

(52) U.S. Cl. 429/53; 429/62; 429/181; 429/174

(57) ABSTRACT

A hermetically sealed battery with an opening-sealing unit 10 according to the present invention comprises a PTC element ring 16 elastically clamped between the flange 12a of a positive electrode cap 12 and a fold portion 11d formed at the peripheral portion 11c of a bottom plate 11, such that when the temperature of the PTC element rises due to overcurrent or overheating, the PTC element ring 16 can easily expand, thereby tripping the large current with its resistance capacity increased to a predetermined level at a predetermined temperature, thereby enhancing operational security of the battery.

### BACKGROUND OF THE INVENTION

1. Field of the Invention

The present invention relates to a hermetically sealed battery such as a nickel-hydrogen battery (nickel-hydrate battery), nickel-cadmium battery, or lithium ion battery and, particularly, to a hermetically sealed battery comprising an opening-sealing unit including a pressure valve residing in a valve chamber composed of a cap portion serving also as a terminal and a bottom plate for closing the opening of an outside can, and a Positive Temperature Coefficient (PTC) element having the property of expanding due to overcurrent or overheating thereby causing a sudden increase in the resistance value at a prescribed temperature or higher, the PTC element being affixed to a part of the opening sealing unit.

2. Description of the Related Art

Generally, a hermetically sealed battery such as a nickel-hydrogen battery, or a nickel-cadmium battery and the like is operated at an applied voltage of about 1.2V in the discharge mode. As a result, a battery of the so-called AA or AAA size can be used as a compatible battery for an AA or AAA size manganese dry cell or alkali primary battery (alkali dry cell). When a manganese dry cell or alkali dry cell is used in an erroneous manner, e.g., when the external circuit on the load side is short-circuited or when the battery is inversely mounted, a large output current does not flow because of inferior output property. However, since the above described hermetically sealed battery is capable of supplying a large discharge current, a burnout often takes place due to overheating and/or heavy current flow with a large discharge current.

To prevent the occurrence of such burnout due to overheating and/or heavy current flow, a lithium ion battery normally includes either a PTC element for suppressing the flow of a large current with an increased resistance resulting from the increase in temperature, or a breaker for interrupting such flow. For instance, Japanese Patent Laid-Open publication No. H02 (1990)-207450 has proposed that the PTC element be disposed on the bottom of the outside can where the bottom is used as a terminal for the positive electrode. If, however, such a PTC element is mounted upon a location other than the opening-sealing unit, the accuracy of monitoring the temperature inside the valve chamber is reduced. In view thereof, Japanese Patent Publication No. 3143176 has proposed that the PTC element be disposed in an opening-sealing unit having a valve element.

The structure of such an opening-sealing unit having a PTC element (shown in FIG. 3) comprises a positive electrode cap 31 made in the shape of a cap and a bottom plate 34 made in the shape of a dish. The positive electrode cap 31 is composed of a convex portion 32 swelling outwardly from the battery and a sheet-like flange portion 33 forming the bottom of the convex portion 32, with the convex portion 32 having a plurality of gas discharging holes 32a at the corners thereof. On the other hand, the bottom plate 34 has a concave portion 35 swelling inwardly towards the battery and a sheet-like flange portion 36 forming the bottom of the concave portion 35, with the concave portion 35 having a plurality of gas discharging holes 35a at the corners thereof.

An electric power guiding plate 37 which deforms at a gas pressure greater than a predetermined value inside the battery is made to reside at the space between the positive electrode cap 31 and bottom plate 34. The electric power guiding plate 37 consists of a concave portion 37a and a flange portion 37b, both made of aluminum foil. The concave portion 37a is disposed in such manner as to be in contact with the upper surface of the concave portion 35 of the bottom plate 34. The flange portion 37b is clamped between the flange portion 33 of the positive electrode cap 31 and the flange portion 36 of the bottom plate 34. The positive electrode cap 31 and the bottom plate 34 are then sealed together liquid tight through an isolation gasket 39.

A PTC element 38 is made to reside on the upper part of the flange portion 37b. When an overcurrent flows in the battery, abnormal heat is generated, increasing the resistance of the PTC element 38, which in turn suppresses the overcurrent. Furthermore, when the increase in gas pressure inside the battery is greater than a predetermined value, the concave portion 37a of the electric power guiding plate 37 is deformed. Accordingly, the electric power guiding plate 37 is disconnected from the concave portion 35 of the bottom plate 34 thereby interrupting the overcurrent or short-circuit current.

However, as shown in FIG. 4, in an alkali secondary battery using an opening-sealing unit without a PTC element, the opening-sealing unit 40 is designed in such a way that the thickness at the peripheral part (the part to be caulked to an outside can 47 through an insulation gasket 46) is reduced, allowing for an increase in the volume of the battery, thereby increasing the capacity of electric charge to be discharged. That is, the opening-sealing unit 40 shown in FIG. 4 comprises a positive electrode cap 41 made in the shape of a cap and a bottom plate 42 formed in the shape of a dish, welded to each other.

A gas discharging opening 42a is formed at the center of the bottom plate 42, and a flange portion 42b is formed at the periphery of the bottom plate 42. A pressure valve consisting of a valve plate 43 and a spring 45 is disposed in the space between the positive electrode cap 41 and the bottom plate 42. A nickel-plated steel plate 44 is interposed between the valve plate 43 and the spring 45. The flange portion 42b of the bottom plate 42 is clamped by an insulation gasket 46, which is disposed on the deep-drawn portion 47a formed on the upper part of the outside can 47, and is caulked to the upper portion 47b of the outside can 47.

However, as shown in FIG. 3, when the PTC element 38 is built into the opening-sealing unit 30, a laminate structure consisting of the flange portion 36 of the bottom plate 34, the insulation gasket 39, the PTC element 38, the flange portion 33 of the positive electrode cap 31, and a caulking portion 36a of the bottom plate 34 is formed. Therefore, the periphery of the opening-sealing unit 30 (the portion to be caulked to the outside can through the isolation gasket) becomes thicker, inevitably reducing the housing capacity for the electrode group at the expense of the charge capacity of the battery when the opening-sealing unit containing such PTC element is adopted.

As distinguished from the lithium battery, the alkali secondary battery is provided with a non-fracture type resilient valve for discharging gas. Therefore, when a functional component such as the PTC element is disposed inside the opening sealing unit, alkali mist normally discharged in minute amounts causes the PTC element to deteriorate, thereby making integration of the PTC element difficult.

Accordingly, the present inventors have proposed in Japanese Patent Application No. 2003-61164 a hermetically sealed battery in which an opening-sealing unit is suitably equipped with a PTC element for the alkali secondary battery without reducing the volume of the outside can, to prevent the generation of a large current in case a short circuit occurs, thereby greatly enhancing operational security. As shown in FIG. 5, the PTC element 56 in the hermetically sealed battery of Japanese Patent Application 2003-61164 is disposed on the upper surface of the flange portion 52a of a positive electrode cap 52, such that it can be insulated from the valve chamber 52, as to prevent the electrolyte from adhering to the PTC element 56, thereby making it possible to suppress the deterioration of the latter. Moreover, since it is disposed adjacent to the valve chamber 52, the internal temperature of the valve chamber 52 can be monitored with higher accuracy.

Furthermore, since the PTC element 56 is caulked to the upper surface of the flange portion 52a of the positive electrode cap 52 through a caulking portion 51e formed at the periphery of a bottom plate 51, it is not necessary to dispose the PTC element 56 on the outermost part of the bottom plate 51. Consequently, the thickness of the caulking portion 51e can be reduced when the opening-sealing unit 50 is mounted on the opening of an outside can 58. Accordingly, the opening close unit 50 provided with the PTC element 56 can be mounted on the opening of the outside can 58 without reducing the capacity of the outside can. In this manner, a hermetically sealed battery which is capable of suppressing the generation of a large current in the event of a short circuit, thereby enhancing operational security, can be provided.

Although such kind of PTC element used in the opening-sealing unit is capable of causing a sudden increase in resistance when its temperature rises due to overcurrent or overheating which occurs when the conductive path of the carbon dispersed in the polymer is cut due to the thermal expansion of the polymer, the PTC element 56 cannot easily expand when it is caulked to the upper surface of the flange portion 52a of the positive electrode cap 52 through the caulking portion 51e formed at the periphery of the bottom plate 51 as described above, therefore limiting its capacity to rise to a predetermined level of resistance even at a predetermined temperature, or trip a large current.

### SUMMARY OF THE INVENTION

Accordingly, the present invention aims to overcome the above-described problems in the prior art, and it is the object of the present invention to provide a hermetically sealed battery by adopting an opening-sealing unit assembled in such manner as to enable the PTC element to easily expand when its temperature rises due to overcurrent or overheating, thereby preventing excessive increases in temperature as well as the generation of a large current or short circuit, effectively enhancing operational security.

To attain the above object, the hermetically sealed battery of the present invention comprises an opening-sealing unit equipped with a pressure valve in a valve chamber comprising a cap portion which also serves as a terminal and a bottom plate for sealing the opening of an outside can, and a Positive Temperature Coefficient (PTC) element having the capacity to expand due to the large flow of current or overheating as to cause a sudden increase in its level of resistance at a predetermined temperature or higher, the PTC element being affixed to a part of the opening-sealing unit, wherein the PTC element is elastically clamped between a flange portion residing in the cap portion thereof and a fold portion formed at the periphery of the bottom plate.

When it is elastically clamped between the flange portion formed in the cap portion and the fold portion formed at the periphery of the bottom plate, the PTC element can easily expand when its temperature increases. Accordingly, the PTC element can trip a large current with a rise in resistance to a predetermined level at a predetermined temperature. Further, the PTC element can be elastically clamped between the flange portion formed in the cap portion and the fold portion residing at the periphery of the bottom plate caulked with a spring.

In this manner, an insulation ring having a standing end portion is disposed between the bottom plate and the flange portion formed in the cap portion. The standing end portion is raised along the peripheral end of the flange portion. When the tip of the standing end portion is extended to the upper surface of the PTC element, the extended portion of the insulation ring functions as cushioning material. Therefore, breakage of the PTC element due to caulking pressure can be prevented during the process of assembling the opening-sealing unit.

Further, when the thickness of the insulation ring, which is disposed between the bottom plate and the flange portion formed in the cap portion, is set to a level that is 50% or more than that of the PTC element, the expansion of the PTC element by way of thickness can be absorbed by the thickness of the insulation ring. As a result, any obstacle to the directional expansion of the PTC element in thickness can be eliminated. When a ring-like projection (minute projection) protruding toward the PTC element is provided on the flange portion formed in the cap so as to allow the PTC element to remain stationary in this projected state, the PTC element can lie in a semi-hanging (linear contact) state relative to the flange portion, generating freedom in its directional expansion. Thus, the PTC element becomes expansible also in the horizontal direction.

In the opening-sealing unit, the PTC element is set in such manner that the elemental temperature will not exceed 80° C. when heat is generated by a current corresponding to short-circuit current flowing in the single use of the PTC element. As a result, the temperature of the battery equipped with such an opening-sealing unit can be set so as not to exceed 80° C. even when a short circuit occurs. Accordingly, the tripping temperature of the PTC element is preferably set to 80° C. or lower. Further, when the PTC element is set in such manner that the elemental temperature will not exceed 70° C. due to the generation of heat, the temperature of the battery can be further set so as not to exceed 70° C. From here, it can be deduced that the desirable tripping temperature of the PTC element is 70° C. or lower. And even if the electrolyte is adhered to the inside end surface of the PTC element, deterioration thereof can be prevented by installing a protective film made of olefin resin on the inside surface of the PTC element.

### BRIEF DESCRIPTION OF THE DRAWINGS

FIG. 1 is a partial sectional view of a hermetically sealed battery in which an opening-sealing unit according to the present invention is mounted on the opening of an outside can.

FIG. 2 is an exploded view of the opening close unit shown in FIG. 1.

FIG. 3 is a sectional view of an opening close unit with a PTC element in the prior art.

FIG. 4 is a sectional view of an opening close unit without a PTC element in the prior art.

FIG. 5 is a sectional view of another opening close unit with a PTC element in the prior art.

### DESCRIPTION OF THE PREFERRED EMBODIMENTS

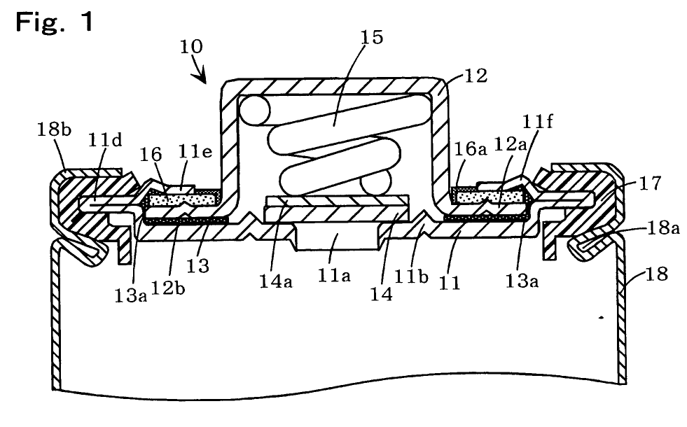

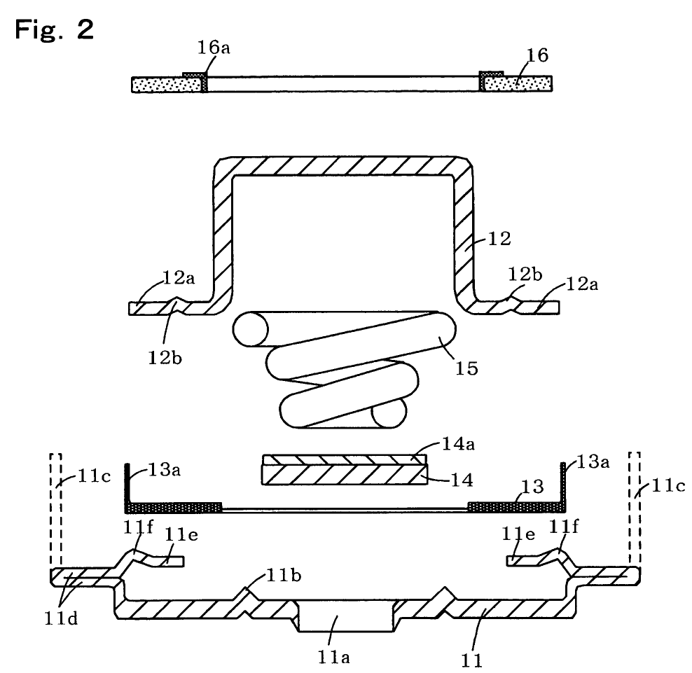

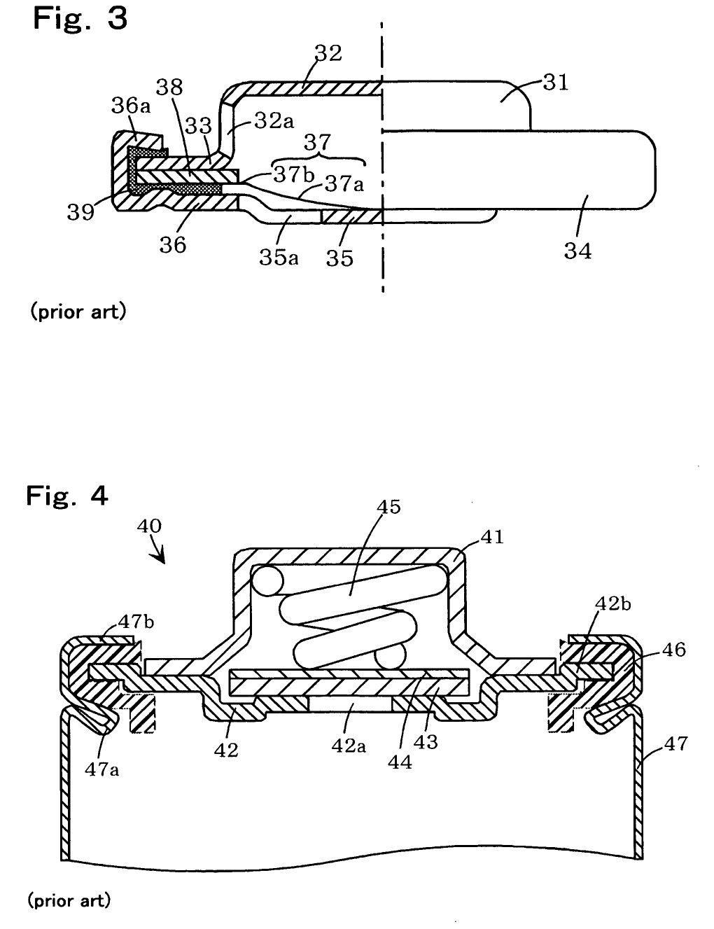

Preferred embodiments of the present invention will be described hereafter as applied to a nickel-hydrogen battery with reference to FIGS. 1 and 2. Note that the present invention is not restricted to the following embodiments, as proper modification and variation thereof is possible without changing its gist. FIG. 1 is a sectional view typically showing an essential part of a hermetically sealed battery comprising an opening-sealing unit mounted on the opening of an outside can, and FIG. 2 is an exploded view showing components of the opening-sealing unit illustrated in FIG. 1.

1. Opening Close Unit

As shown in FIGS. 1 and 2, the opening-sealing unit 10 according to the present invention comprises a bottom plate 11 for sealing the opening of the outside can 18, a positive electrode cap 12 serving as a positive electrode terminal and forming a space (valve chamber) for housing a pressure valve therein, an insulation ring 13, a resilient valve 14 having a nickel-plated steel plate 14a on the upper surface thereof, a spring 15, and a PTC element ring 16 disposed on a flange 12a of the positive electrode cap 12. Whereupon, an insulation gasket 17 is mounted on the periphery of the opening close unit 10 for the purpose of sealing the opening of the outside can 18.

The bottom plate 11 is formed in the shape of a dish from a nickel-plated steel plate, while a gas discharge hole 11a is formed at the center of the dish, and four positional projections 11b for fixing the resilient valve 14 at a predetermined position are formed around the gas discharge hole 11a. A peripheral part 11c (refer to FIG. 2) at the end of the dish-shaped portion of the bottom plate 11 is subjected to deionization (DI) processing, and the thickness thereof is set to half of that of the dish-shaped portion of the bottom plate 11. A fold portion 11d is formed by folding the peripheral part 11c to about one third of the length of the part thinned by DI processing. Then, a caulking portion 11e having a substantially V-shaped sectional bent part 11f for elastically caulking the PTC element ring 16 to the upper surface of the flange 12a of the positive electrode cap 12 (described later) is formed on the inner periphery of the fold portion 11d. According to such a structure, the PTC element ring 16 is elastically clamped between the flange 12a and the caulking portion 11e with the substantially V-shaped bent part 11f functioning as a spring, so that the PTC element ring 16 can expand vertically.

The positive electrode cap 12 is formed from a nickel-plated steel plate, and made to swell in the shape of a cap at the center, and the flange 12a is formed on the peripheral part, which corresponds to the bottom part of the positive electrode cap 12. A ring-like projection (e.g., with a height of 3/100-8/100 mm) 12b is formed on the flange 12a by press working, so that the PTC element ring remains stationary in a semi-hanging state relative to the flange 12a when it is disposed thereon. In this manner, the PTC element ring 16 can also expand in the horizontal direction. The flange 12a of the positive electrode cap 12 is designed in such a way that its diameter is somewhat smaller than the diagonal distance between the ends of the dish-shaped portion of the bottom plate 11. Furthermore, gas discharge holes (not shown) are formed on the sidewall of the positive electrode cap 12.

The isolation ring 13 is in the shape of a ring formed from polypropylene (PP) or nylon with such a diameter that it can be interposed between the ends of the dish-shaped portion of the bottom plate 11. Moreover, the isolation ring 13 has an opening slightly larger in diameter than that of the circle formed by the four positional projections 11b of the bottom plate 11. In addition, the standing end portion 13a is formed at the peripheral end of the isolation ring 13. The height of the standing end portion 13a is set slightly larger than the total thickness of the flange 12a of the positive electrode cap 12 and the PTC element ring 16, so that part of the tip of the standing end portion 13a covers part of the upper surface of the PTC element ring 16.

When the caulking portion 11e of the bottom plate 11 is bent to substantially form a V-shape, and the upper surface of the PTC element ring 16 disposed on the inner side thereof is caulked to the flange 12a side of the positive electrode cap 12, the corners of the PTC element ring 16 are protected by the tip of the standing end portion 13a, and breakage of the corners can thus be prevented. In this case, the thickness of the insulation ring 13 disposed between the bottom plate 11 and the flange 12a of the positive electrode cap 12 is set to 50% or more than that of the PTC element ring 16. As a result, since the expansion of the PTC element ring 16 can be absorbed by the thickness of the insulation ring 13, any obstacle to the directional expansion of the PTC element ring 16 in thickness can be further prevented.

The insulation ring 13 is then arranged, whereby contact between the flange 12a residing at the periphery of the positive electrode cap 12 and the fold portion 11d formed in the bottom plate 11 can be prevented even if the flange 12a is mounted on the insulation ring 13. As a result, when the PTC element ring 16 is disposed on the flange 12a of the positive electrode cap 12 in the latter step, a discharge current flows to the positive electrode cap 12 through the fold portion 11d formed in the bottom plate 11, the caulking portion 11e, the PTC element ring 16 and the flange 12a.

The resilient value 14 is made of ethylene-propylene gum (EPDM). and disposed in such manner as to close the gas discharge hole 11a formed at the center of the dish-shaped portion of the bottom plate 11. The nickel-plated steel plate 14a is disposed on the upper surface of the resilient valve 14, while the spring 15 is further disposed on the nickel-plated steel plate 14a in order to exert a press force thereto. According to such a structure, when the inner space of the battery is pressurized to a predetermined value or higher, the resilient valve 14 is pushed up against the press force resulting from the spring 15 to discharge a gas from the gas discharge hole (not shown) in the positive electrode cap 12, so that the internal pressure of the battery can be reduced.

The PTC element ring 16 is a Positive Temperature Coefficient (PTC) element made of a conductive polymer (commercially available under the trade name “Polyswitch” and manufactured by Raychem Corporation), having the capacity to expand when a large flow of current or overheating occurs, causing its level of resistance to increase suddenly at a predetermined temperature or higher. An element P1 (middle-pressure general product), the elemental temperature of which becomes 100° C. by heat generation when carrying a current of 10 A in a single use thereof, and an element P2 (low-temperature operation specification), the elemental temperature of which becomes 70° C., are used.

An olefin resin film 16a is formed on the inner wall surface of the PTC element ring (P1, P2) 16, to prevent deterioration thereof by the adhesion of alkali mist and the like. An opening slightly larger in diameter than that of the swelling portion of the positive electrode cap 12 is formed at the center of the PTC element ring (P1, P2) 16, and disposed on the upper surface of the flange 12a of the positive electrode cap 12. Accordingly, the discharge current flows into the positive electrode cap 12 through the fold portion 11d formed in the bottom plate 11, the caulking portion 11e, the PTC element ring (P1, P2) 16 and the flange 12a.

2. Assembly of the Opening-Sealing Unit

The method of assembling the opening-sealing unit 10 constituted in the manner described above is hereafter explained. Firstly, the bottom plate 11 having the gas discharge hole 11a formed at the center of the dish-shaped portion and four positional projections 11b formed around the gas discharge hole 11a is prepared. Then, the peripheral portion 11c side at the end of the dish-shaped portion of the bottom plate 11 is subjected to DI processing and thinned to a thickness half of that of the dish-shaped portion. Thereafter, the DI processed portion is bent to become L-shaped so that the opening-sealing unit shall have a predetermined diameter to form a bent portion 11c (refer to the broken lines in FIG. 2).

Subsequently, the insulation ring 13 having the standing end portion 13a formed at the peripheral end thereof is mounted onto the dish-shaped portion of the bottom plate 11, and the resilient valve 14 is disposed so as to close the gas discharge hole 11a formed at the center of the dish-shaped portion. Thereafter, the spring 15 is mounted on the nickel-plated steel plate 14a disposed on the upper surface of the resilient valve 14, and the flange 12a of the positive electrode cap 12 is disposed on the insulation ring 13. Subsequently, the PTC element ring 16 is mounted on the flange 12a, and the bent portion 11c of the bottom plate 11 is folded inwardly to form a fold portion 11d.

Thereafter, the tip of the bent portion 11c is further bent to become substantially V-shaped toward the flange 12a of the positive electrode cap 12 to form a V-shaped bent portion 11f, and then the PTC element ring (P1, P2) 16 is elastically caulked to the upper surface of the flange 12a in the positive electrode cap 12. Since the corners of the PTC element ring (P1, P2) 16 are protected by the tip of the standing end portion 13a, breakage of the corners can be prevented. Accordingly, the resilient valve 14 blocks the gas discharge hole 11a with a press force coming from the spring 15, and the opening-sealing unit 10 is thus formed.

3. Production of Nickel-Hydrogen Battery

The production of a nickel-hydrogen battery using the thus-prepared opening-sealing unit 10 will hereafter be exemplified. Firstly, a nickel-sintered porous element is formed on the surface of an electrode plate core body made of a punching metal, and then the nickel sintered porous element is filled with an active material mainly composed of nickel hydroxide by means of a chemical impregnation method to form a nickel positive electrode plate. On the other hand, the surface of an electrode plate core body made of foamed nickel is filled with a paste-like negative electrode active material consisting of a hydrogen storage alloy and thereafter the electrode plate core body is dried and rolled to a predetermined thickness to produce a hydrogen storage alloy negative electrode plate.

The thus-produced nickel electrode plate and hydrogen storage alloy negative electrode plate are helically wound with a separator interposed between them to form a helical electrode group. The end portion of the electrode plate core body of the nickel positive electrode plate is then exposed onto the upper end surface of the helical electrode group, and the end portion of the electrode plate core body of the hydrogen storage alloy negative electrode plate is also exposed onto the lower end surface of the helical electrode group. The core body exposed onto the upper end surface of the helical electrode group is welded to a positive electrode collector, while the core body exposed onto the lower end surface is welded to a negative electrode collector. A positive electrode lead wire is provided extending from the end of the positive electrode collector, and the end of the positive electrode lead wire is thereafter welded to the lower end surface of the opening close unit after fitting the insulation gasket.

In the next step, the helical electrode group is housed in the bottom of the cylindrical outside can (the outer surface of the bottom serves as an external terminal for the negative electrode) 18 made of a nickel-plated iron sheet, and the negative electrode collector is spot-welded to the inner bottom of the outside can 18. Thereafter, a groove 18a is formed on the upper peripheral surface of the outside can 18. Furthermore, the positive electrode lead wire extending from the positive electrode collector is bent at right angles, and the end of the positive electrode lead wire is then resistance-welded to the bottom plate 11 of the opening-sealing unit 10. Thereafter, an alkali electrolyte of 30 wt % aqueous solution of potassium hydroxide (KOH) is injected to the outside can 18.

In the next step, the polypropylene (PP)-made insulation gasket 17 is installed to the fold portion 11d of the bottom plate 11 which serves as a flange portion of the opening close unit 10, and the opening close unit 10 is mounted on the opening of the outside can 18 with the positive electrode lead wire being bent. Thereafter, the opening edge 18b of the outside can 18 is caulked inwardly to hermetically seal the opening. Nickel-hydrogen batteries A1, A2 having a nominal capacity of 1.7 Ah are thereby produced. The nickel-hydrogen battery with the opening close unit 10 produced by using the element P1 as the PTC element ring 16 is hereafter referred to as A1, and the nickel-hydrogen battery with the opening close unit 10 produced by using the element P2 as the PTC element ring 16 is hereafter referred to as A2.

4. Short Circuit Test

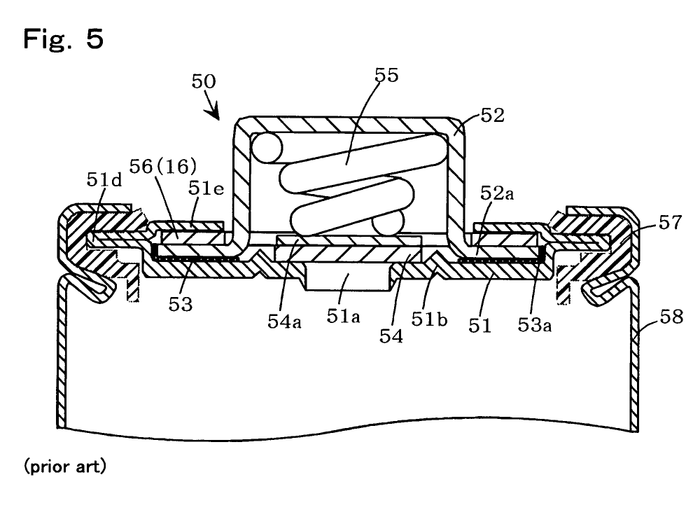

Using the above described PTC element rings (P1, P2) 16, opening close units 50 were assembled having the structure shown in FIG. 5, and thereafter, nickel-hydrogen batteries (nominal capacity 1.7 Ah) X1 (using the element P1) and X2 (using the element P2) were produced using the aforementioned opening close units 50. Thereafter, a short circuit test was carried out using three pieces each of the thus-produced nickel-hydrogen batteries A1, A2 and nickel-hydrogen batteries X1, X2. In the short circuit test, the positive electrode was connected to the negative electrode via a conductor, so that each of the batteries A1, A2 and X1, X2 was externally short-circuited to operate each PTC element ring (P1, P2) 16.

The temperature of the positive electrode cap 12 (52) (Tp temperature) (° C.) and the battery body temperature (Tc temperature) (° C.) of each of the batteries A1, A2 and X1 and X2 were measured during the interruption of current in each PTC element ring (P1, P2) 16 upon self-heating. The results obtained are shown in Table 1.

TABLE 1

| | PTC | Tp Temperature | | | Tc Temperature | | | |
|---|---|---|---|---|---|---|---|---|
| Battery | Element | (° C.) | | | (° C.) | | | State of |
| Type | Type | No. 1 | No. 2 | No. 3 | No. 1 | No. 2 | No. 3 | Heating |
| A1 | P1 | 82 | 77 | 79 | 61 | 54 | 58 | Moderate |
| | | | | | | | | heat |
| | | | | | | | | generation |
| A2 | P2 | 66 | 63 | 64 | 49 | 52 | 51 | Small heat |
| | | | | | | | | generation |
| X1 | P1 | 118 | 135 | 129 | 86 | 95 | 92 | Large heat |
| | | | | | | | | generation |
| X2 | P2 | 70 | 91 | 95 | 53 | 69 | 74 | Unstable |
| | | | | | | | | middle |
| | | | | | | | | heat |
| | | | | | | | | generation |

As is apparent from the results shown in Table 1, when the PTC element ring 16 consisting of the middle-pressure general product element P1 (with elemental temperature of 100° C. in 10A-operation) is used, the battery A1 has a moderate heating value with the temperature (Tp temperature) of the positive electrode cap 12 registering 82° C., 77° C. and 79° C. (averaging 79.3° C.) and the battery body temperature (Tc temperature) registering 61° C., 54° C. and 58° C. (averaging 57.7° C.), while the battery X1 has a large heating value with the temperature of the positive electrode cap 52 (Tp temperature) measuring 118° C., 135° C. and 129° C. (averaging 127.3° C.) and the battery body temperature (Tc temperature) measuring 86° C., 95° C. and 92° C. (averaging 91.0° C.).

On the other hand, when the PTC element ring 16 consisting of the element P2 of low-temperature operation specification (with elemental temperature of 70° C. in 10A-operation) is used, the battery A2 has a small heating value with the temperature of the positive electrode cap 12 registering 66° C., 63° C. and 64° C. (averaging 64.3° C.) and the battery body temperature (Tc temperature) registering 49° C., 52° C. and 51° C. (averaging 50.7° C.), while the battery X2, producing a moderate heating value, showed unstable characteristics with the temperature of the positive electrode cap 52 (Tp temperature) measuring 70° C., 91° C. and 95° C. (averaging 85.3° C.) and the battery body temperature (Tc temperature) measuring 53° C., 69° C. and 74° C. (averaging 65.3° C.).

The results show that the heating value can be more easily reduced by using the element P2 of low-temperature operation specification. However, it is conceived that since the resin used in the element P2 of low-temperature operation specification (generally, EBA resin) is soft, the PTC element ring (P2) 16 is softened and crushed and would not exhibit prescribed characteristics when it is installed in the opening-sealing unit 50 having the caulking structure shown in FIG. 5. On the other hand, when the element P2 of low-temperature operation specification is used, the PTC element ring (P2) 16 can easily expand without being softened or crushed as a result of the rise in temperature when assembled to the opening close unit 10 having the caulking structure as shown in FIG. 1.

This likewise indicates that both the PTC element ring 16 made of the middle pressure general product element P1 (elemental temperature 100° C. in 10A-operation) and the PTC element ring 16 made of the element P2 of low-temperature operation specification (elemental temperature 70° C. in 10 A-operation) can easily expand as a result of a rise in temperature and sufficiently exhibit the prescribed characteristics when installed in the opening close unit 10 having the caulking structure shown in FIG. 1.

As described above, in accordance with the present invention, since the PTC element ring 16 is elastically clamped between the flange 12a of the positive electrode cap 12 and the fold portion 11d formed in the peripheral portion 11c of the bottom plate 11, the PTC element ring 16 can easily expand when the temperature increases. Accordingly, the PTC element ring 16 can trip a large current with a resistance increased to a predetermined value at a predetermined temperature, and an operationally secure hermetically sealed battery is thereby provided.

While the above described preferred embodiments merely refer to the application of the present invention to the nickel-hydrogen battery, it is obvious that the present invention may also be applied to other types of hermetically sealed batteries, such as nickel cadmium battery, lithium ion battery and the like.

1. A hermetically sealed battery comprising an opening-sealing unit having a pressure valve contained in a valve chamber formed by a cap portion serving also as a terminal and a bottom plate for sealing the opening of an outside can, and a Positive Temperature Coefficient (PTC) element having the capacity to expand when an overcurrent or overheating occurs, causing a sudden increase in resistance value at a predetermined temperature or higher, said PTC element being affixed to a part of the said opening-sealing unit,
wherein the PTC element is elastically clamped between a flange portion formed in the said cap portion and a fold portion formed at the peripheral part of the said bottom plate.

2. A hermetically sealed battery according to claim 1, wherein the said flange portion comprises a ring-like projection protruding toward the said PTC element, so that the position of the PTC element is determined by the said projection.

3. A hermetically sealed battery according to claim 1, wherein the said PTC element has a tripping temperature of 80° C. or lower.

4. A hermetically sealed battery according to claim 1, wherein the said flange portion comprises a ring-like projection protruding toward the said PTC element, so that the position of the PTC element is determined by the said projection, and the PTC element has a tripping temperature of 80° C. or lower.

5. A hermetically sealed battery comprising an opening-sealing unit having a pressure valve contained within a valve chamber formed by a cap portion serving also as a terminal and a bottom plate for sealing the opening of an outside can, and a PTC element having the capacity to expand when an overcurrent or overheating occurs, causing a sudden increase in resistance value at a predetermined temperature or higher, the said PTC element being affixed to a part of the said opening-sealing unit,
wherein the PTC element is elastically clamped between a flange portion formed in the said cap portion and a fold portion formed at the peripheral part of the said bottom plate, and said fold portion is equipped with a caulking portion having the capacity of a spring, thereby elastically clamping the PTC element between the said flange portion and the said fold portion.

6. A hermetically sealed battery according to claim 5, wherein the said flange portion comprises a ring-like projection protruding toward the said PTC element, so that the position of the PTC element is determined by the said projection.

7. A hermetically sealed battery according to claim 5, wherein the said PTC element has a tripping temperature of 80° C. or lower.

8. A hermetically sealed battery according to claim 5, wherein the said flange portion comprises a ring-like projection protruding toward the said PTC element, so that the position of the PTC element is determined by the said projection, and the PTC element has a tripping temperature of 80° C. or lower.

9. A hermetically sealed battery comprising an opening-sealing unit having a pressure valve contained in a valve chamber formed by a cap portion serving also as a terminal and a bottom plate for sealing the opening of an outside can, and a PTC element having the capacity to expand when an overcurrent or overheating occurs, causing a sudden increase in resistance value at a predetermined temperature or higher, said PTC element being affixed to a part of the said opening-sealing unit,
wherein the PTC element is elastically clamped between a flange portion formed in the said cap portion and a fold portion formed at the peripheral part of the said bottom plate, with an insulation ring having a standing end portion disposed between the bottom plate and the said flange portion, the said standing end portion being raised along the peripheral end of the flange portion, and the tip of the standing end portion is extended to the upper surface of the PTC element.

10. A hermetically sealed battery according to claim 9, wherein said the flange portion comprises a ring-like projection protruding toward the said PTC element, so that the position of the PTC element is determined by the said projection.

11. A hermetically sealed battery according to claim 9, wherein the said PTC element has a tripping temperature of 80° C. or lower.

12. A hermetically sealed battery according to claim 9, wherein the said flange portion comprises a ring-like projection protruding toward the said PTC element, so that the position of the PTC element is determined by the said projection, and the PTC element has a tripping temperature of 80° C. or lower.

13. A hermetically sealed battery according to claim 9, wherein the thickness of the said insulation ring disposed between the said bottom plate and the thickness of the said flange portion is set to 50% or more than that of the said PTC element.

14. A hermetically sealed battery according to claim 13, wherein the said flange portion comprises a ring-like projection protruding toward the said PTC element, so that the position of the PTC element is determined by the said projection.

15. A hermetically sealed battery according to claim 13, wherein the said PTC element has a tripping temperature of 80° C. or lower.

16. A hermetically sealed battery according to claim 13, wherein the said flange portion comprises a ring-like projection protruding toward the said PTC element, so that the position of the PTC element is determined by the said projection, and the PTC element has a tripping temperature of 80° C. or lower.
